(19) United States
(12) Patent Application Publication
(10) Pub. No.: US 2018/0074661 A1
(43) Pub. Date: Mar. 15, 2018

(54) PREFERRED EMOJI IDENTIFICATION AND GENERATION

(71) Applicant: GM Global Technology Operations LLC, Detroit, MI (US)

(72) Inventors: Xu Fang Zhao, WINDSOR (CA); Gaurav Talwar, NOVI, MI (US)

(21) Appl. No.: 15/265,522

(22) Filed: Sep. 14, 2016

(51) Int. Cl. G06F 3/0482; G06F 3/0481; G06F 3/16; G06F 3/01; G06F 3/0488; G10L 15/24; G10L 15/08; G06F 17/30

(52) U.S. Cl. CPC G06F 3/0482; G06F 3/04817; G06F 3/167; G06F 3/017; H04L 51/08; G06F 3/04883; G10L 15/24; G10L 15/08; G06F 17/3028; G06F 3/012

(57) ABSTRACT

A system and method of identifying and generating preferred emojis includes: detecting at a wireless device a plurality of selected emoji; determining the frequency with which each emoji is selected; identifying a defined number of emojis from the plurality of selected emojis based on the frequency with which each emoji is selected; and creating a frequently-used emoji library for the identified emojis.

### TECHNICAL FIELD

The present invention relates to using emojis and, more particularly, to identifying and generating emojis that are most-often sent by a user.

### BACKGROUND

Electronic device users are sending more complex electronic messages using their devices. In the past, electronic messages solely included text content that users added using a keyboard. Electronic messages have evolved so that content other than text can be included. For example, electronic device users can select from a wide array of emojis that can be included in the electronic messages. Emojis are small, artistic images that graphically express an idea and can be included in the electronic messages. Many electronic devices include a library that contains many emojis the user can browse and select for inclusion in their messages. Even though the users have access to a many different emojis, the messages users send often only include a small subset of the emojis available in the library of the device. Identifying and selecting the most-frequently used emojis in the library can be more efficiently accomplished.

### SUMMARY

According to an embodiment, there is provided a method of identifying and generating preferred emojis. The method includes detecting at a wireless device a plurality of selected emoji; determining the frequency with which each emoji is selected; identifying a defined number of emojis from the plurality of selected emojis based on the frequency with which each emoji is selected; and creating a frequently-used emoji library for the identified emojis.

According to another embodiment, there is provided a method of identifying and generating preferred emojis. The method includes initiating an electronic message at a wireless device; receiving speech describing an emoji for inclusion in the electronic message; comparing the received speech with emoji descriptions stored in a frequently-used emoji library; identifying an emoji based on the comparison; and inserting the emoji into the electronic message.

According to yet another embodiment, there is provided a method of identifying and generating preferred emojis. The method includes initiating an electronic message at a wireless device; receiving a user-defined input identifying an emoji for inclusion in the electronic message; comparing the received user-defined input with previously-stored user-defined input and emoji associations stored in a frequently-used emoji library; identifying an emoji based on the comparison; and inserting the emoji into the electronic message.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein; and

FIG. 2 is a block diagram depicting an embodiment of a text-to-speech (TTS) system that is capable of utilizing the method disclosed herein;

FIG. 3 is a block diagram depicting an embodiment of an automatic speech recognition (ASR) system that is capable of utilizing the method disclosed herein; and

FIG. 4 is a flow chart depicting an embodiment of a method of identifying and generating preferred emojis.

### DETAILED DESCRIPTION OF THE ILLUSTRATED EMBODIMENT(S)

The system and method described below identifies the emojis most-frequently selected by a user of a wireless device and facilitates inserting these emojis into electronic messages. A wireless device can monitor the emojis the wireless device user sends over a period of time. The wireless device can count the number of times a user sends a particular emoji and, after the period of time passes, the wireless device can determine the most-frequently sent emojis. The wireless device and then create a frequently-used emoji library of these emojis. The frequently-used emoji library can link the most-frequently used emojis with text descriptions of those emojis. The text description can include the universally-agreed on description of each emoji as well as user-defined definitions that are added by a particular user or based on surveys of users.

The emojis in the frequently-used emoji library can be linked with a user-defined input that a wireless device can detect. For instance, the user-defined input can be a facial expression that is recognizable by a camera. The user can identify an emoji in the frequently-used emoji library and pair the emoji with a particular facial expression. When the user wants to add that emoji to an electronic message, the user can make the facial expression associated with the emoji, the camera will detect this facial expression, access the emoji associated with the expression, and add the emoji to the electronic message. In another example, the user defined input can be the movement of the user's finger in a particular pattern over a touch pad or touch screen. The user can identify an emoji in the frequently-used emoji library and pair the emoji with a particular pattern the user traces with his or her finger. When the user wants to add that emoji to an electronic message, the user can draw the particular pattern associated with the emoji on the touch screen, the wireless device associated with the touch screen will detect this pattern, access the emoji associated with the pattern, and add the emoji to the electronic message.

### Communications System—

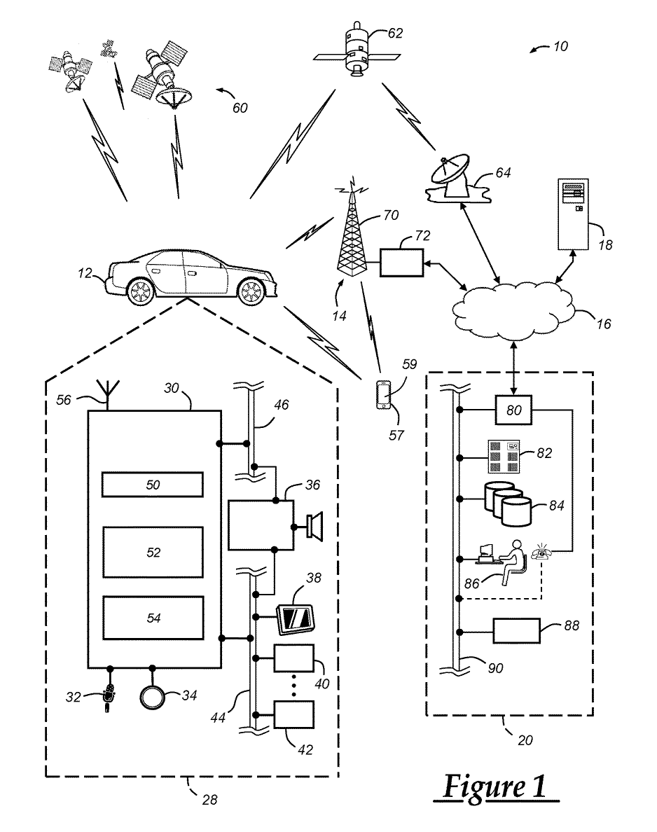

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of other vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 is itself a vehicle system module (VSM) and can be implemented as an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM, CDMA, or LTE standards and thus includes a standard cellular chipset 50 for voice communications like hands-free calling, a wireless modem for data transmission, an electronic processing device 52, one or more digital memory devices 54, and a dual antenna 56. It should be appreciated that the modem can either be implemented through software that is stored in the telematics unit and is executed by processor 52, or it can be a separate hardware component located internal or external to telematics unit 30. The modem can operate using any number of different standards or protocols such as LTE, EVDO, CDMA, GPRS, and EDGE. Wireless networking between the vehicle and other networked devices can also be carried out using telematics unit 30. For this purpose, telematics unit 30 can be configured to communicate wirelessly according to one or more wireless protocols, including short range wireless communication (SRWC) such as any of the IEEE 802.11 protocols, WiMAX, ZigBee™ Wi-Fi direct, Bluetooth™, or near field communication (NFC). When used for packet-switched data communication such as TCP/IP, the telematics unit can be configured with a static IP address or can be set up to automatically receive an assigned IP address from another device on the network such as a router or from a network address server.

One of the networked devices that can communicate with the telematics unit 30 is a wireless device, such as a smart phone 57. The smart phone 57 can include computer processing capability, a transceiver capable of communicating using a short-range wireless protocol, and a visual smart phone display 59. In some implementations, the smart phone display 59 also includes a touch-screen graphical user interface. The smart phone 57 can also include a GPS module capable of receiving GPS satellite signals and generating GPS coordinates based on those signals. The smart phone 57 also includes one or more microprocessors that execute machine code to generate logical output. One or more cameras can be included in the smart phone 57. A camera can be positioned on an opposite side of the smart phone display 59. But in some configurations the smart phone may have a plurality of cameras, one of which is adjacent to the display 59. Examples of the smart phone 57 include the iPhone manufactured by Apple and the Galaxy manufactured by Samsung, as well as others. While the smart phone 57 may include the ability to communicate via cellular communications using the wireless carrier system 14, this is not always the case. For instance, Apple manufactures devices such as the various models of the iPad and iPod Touch that include the processing capability, the display 59, and the ability to communicate over a short-range wireless communication link. However, the iPod Touch™ and some iPads™ do not have cellular communication capabilities. Even so, these and other similar devices may be used or considered a type of wireless device, such as the smart phone 57, for the purposes of the method described herein.

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein.

Telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the engine control module is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbutton(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. In some implementations, the audio system 36 can be implemented using an infotainment head unit. The infotainment head unit can include one or more computer processors that are capable of operating a transceiver also included with the infotainment head unit. The transceiver can carry out short-range wireless communication of data between the itself and the vehicle telematics unit 30, the smart phone 57, or both. The infotainment head unit can provide audio and visual infotainment content as is known in the art. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

Wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000 or 1×EV-DO) or GSM/GPRS (e.g., 4G LTE). As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

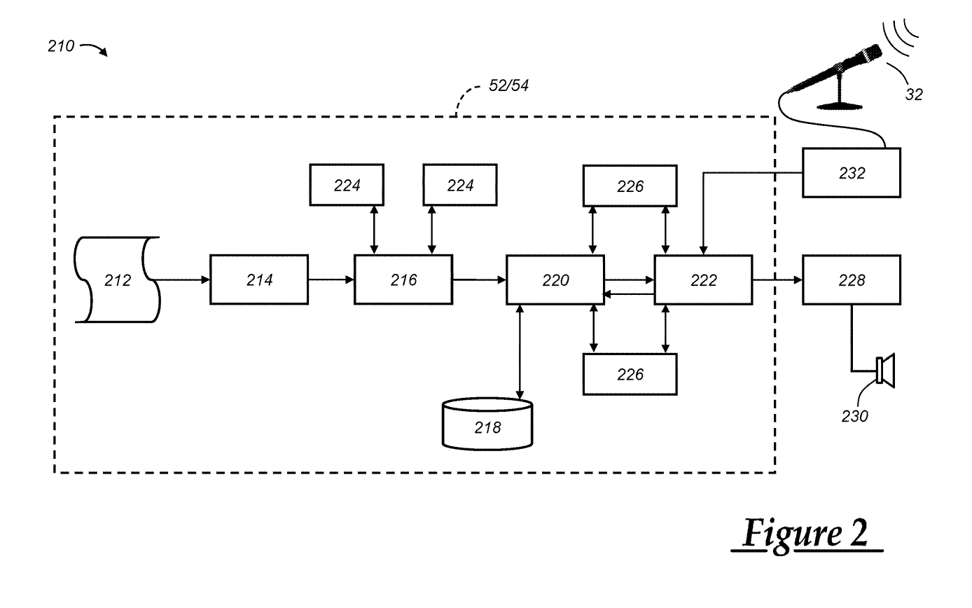

TTS systems are generally known to those skilled in the art, as described in the background section. But FIG. 2 illustrates an example of an improved TTS system according to the present disclosure. According to one embodiment, some or all of the system 210 can be resident on, and processed using, the telematics unit 30 of FIG. 1. According to an alternative illustrative embodiment, some or all of the TTS system 210 can be resident on, and processed using, computing equipment in a location remote from the vehicle 12, for example, the call center 20. For instance, linguistic models, acoustic models, and the like can be stored in memory of one of the servers 82 and/or databases 84 in the call center 20 and communicated to the vehicle telematics unit 30 for in-vehicle TTS processing. Similarly, TTS software can be processed using processors of one of the servers 82 in the call center 20. In other words, the TTS system 210 can be resident in the telematics unit 30 or distributed across the call center 20 and the vehicle 12 in any desired manner.

The system 210 can include one or more text sources 212, and a memory, for example the telematics memory 54, for storing text from the text source 212 and storing TTS software and data. The system 210 can also include a processor, for example the telematics processor 52, to process the text and function with the memory and in conjunction with the following system modules. A pre-processor 214 receives text from the text source 212 and converts the text into suitable words or the like. A synthesis engine 216 converts the output from the pre-processor 214 into appropriate language units like phrases, clauses, and/or sentences. One or more speech databases 218 store recorded speech. A unit selector 220 selects units of stored speech from the database 218 that best correspond to the output from the synthesis engine 216. A post-processor 222 modifies or adapts one or more of the selected units of stored speech. One or more or linguistic models 224 are used as input to the synthesis engine 216, and one or more acoustic models 226 are used as input to the unit selector 220. The system 210 also can include an acoustic interface 228 to convert the selected units of speech into audio signals and a loudspeaker 230, for example of the telematics audio system, to convert the audio signals to audible speech. The system 210 further can include a microphone, for example the telematics microphone 32, and an acoustic interface 232 to digitize speech into acoustic data for use as feedback to the post-processor 222.

The text source 212 can be in any suitable medium and can include any suitable content. For example, the text source 212 can be one or more scanned documents, text files or application data files, or any other suitable computer files, or the like. The text source 212 can include words, numbers, symbols, and/or punctuation to be synthesized into speech and for output to the text converter 214. Any suitable quantity and type of text sources can be used.

The pre-processor 214 converts the text from the text source 212 into words, identifiers, or the like. For example, where text is in numeric format, the pre-processor 214 can convert the numerals to corresponding words. In another example, where the text is punctuation, emphasized with caps or other special characters like umlauts to indicate appropriate stress and intonation, underlining, or bolding, the pre-processor 214 can convert same into output suitable for use by the synthesis engine 216 and/or unit selector 220.

The synthesis engine 216 receives the output from the text converter 214 and can arrange the output into language units that may include one or more sentences, clauses, phrases, words, subwords, and/or the like. The engine 216 may use the linguistic models 224 for assistance with coordination of most likely arrangements of the language units. The linguistic models 224 provide rules, syntax, and/or semantics in arranging the output from the text converter 214 into language units. The models 224 can also define a universe of language units the system 210 expects at any given time in any given TTS mode, and/or can provide rules, etc., governing which types of language units and/or prosody can logically follow other types of language units and/or prosody to form natural sounding speech. The language units can be comprised of phonetic equivalents, like strings of phonemes or the like, and can be in the form of phoneme HMM's.

The speech database 218 includes pre-recorded speech from one or more people. The speech can include pre-recorded sentences, clauses, phrases, words, subwords of pre-recorded words, and the like. The speech database 218 can also include data associated with the pre-recorded speech, for example, metadata to identify recorded speech segments for use by the unit selector 220. Any suitable type and quantity of speech databases can be used.

The unit selector 220 compares output from the synthesis engine 216 to stored speech data and selects stored speech that best corresponds to the synthesis engine output. The speech selected by the unit selector 220 can include pre-recorded sentences, clauses, phrases, words, subwords of pre-recorded words, and/or the like. The selector 220 may use the acoustic models 226 for assistance with comparison and selection of most likely or best corresponding candidates of stored speech. The acoustic models 226 may be used in conjunction with the selector 220 to compare and contrast data of the synthesis engine output and the stored speech data, assess the magnitude of the differences or similarities therebetween, and ultimately use decision logic to identify best matching stored speech data and output corresponding recorded speech.

In general, the best matching speech data is that which has a minimum dissimilarity to, or highest probability of being, the output of the synthesis engine 216 as determined by any of various techniques known to those skilled in the art. Such techniques can include dynamic time-warping classifiers, artificial intelligence techniques, neural networks, free phoneme recognizers, and/or probabilistic pattern matchers such as Hidden Markov Model (HMM) engines. HMM engines are known to those skilled in the art for producing multiple TTS model candidates or hypotheses. The hypotheses are considered in ultimately identifying and selecting that stored speech data which represents the most probable correct interpretation of the synthesis engine output via acoustic feature analysis of the speech. More specifically, an HMM engine generates statistical models in the form of an “N-best” list of language unit hypotheses ranked according to HMM-calculated confidence values or probabilities of an observed sequence of acoustic data given one or another language units, for example, by the application of Bayes' Theorem.

In one embodiment, output from the unit selector 220 can be passed directly to the acoustic interface 228 or through the post-processor 222 without post-processing. In another embodiment, the post-processor 222 may receive the output from the unit selector 220 for further processing.

In either case, the acoustic interface 228 converts digital audio data into analog audio signals. The interface 228 can be a digital to analog conversion device, circuitry, and/or software, or the like. The loudspeaker 230 is an electroacoustic transducer that converts the analog audio signals into speech audible to a user and receivable by the microphone 32.

The method or parts thereof can be implemented in a computer program product embodied in a computer readable medium and including instructions usable by one or more processors of one or more computers of one or more systems to cause the system(s) to implement one or more of the method steps. The computer program product may include one or more software programs comprised of program instructions in source code, object code, executable code or other formats; one or more firmware programs; or hardware description language (HDL) files; and any program related data. The data may include data structures, look-up tables, or data in any other suitable format. The program instructions may include program modules, routines, programs, objects, components, and/or the like. The computer program can be executed on one computer or on multiple computers in communication with one another.

The program(s) can be embodied on computer readable media, which can be non-transitory and can include one or more storage devices, articles of manufacture, or the like. Exemplary computer readable media include computer system memory, e.g. RAM (random access memory), ROM (read only memory); semiconductor memory, e.g. EPROM (erasable, programmable ROM), EEPROM (electrically erasable, programmable ROM), flash memory; magnetic or optical disks or tapes; and/or the like. The computer readable medium may also include computer to computer connections, for example, when data is transferred or provided over a network or another communications connection (either wired, wireless, or a combination thereof). Any combination(s) of the above examples is also included within the scope of the computer-readable media. It is therefore to be understood that the method can be at least partially performed by any electronic articles and/or devices capable of carrying out instructions corresponding to one or more steps of the disclosed method.

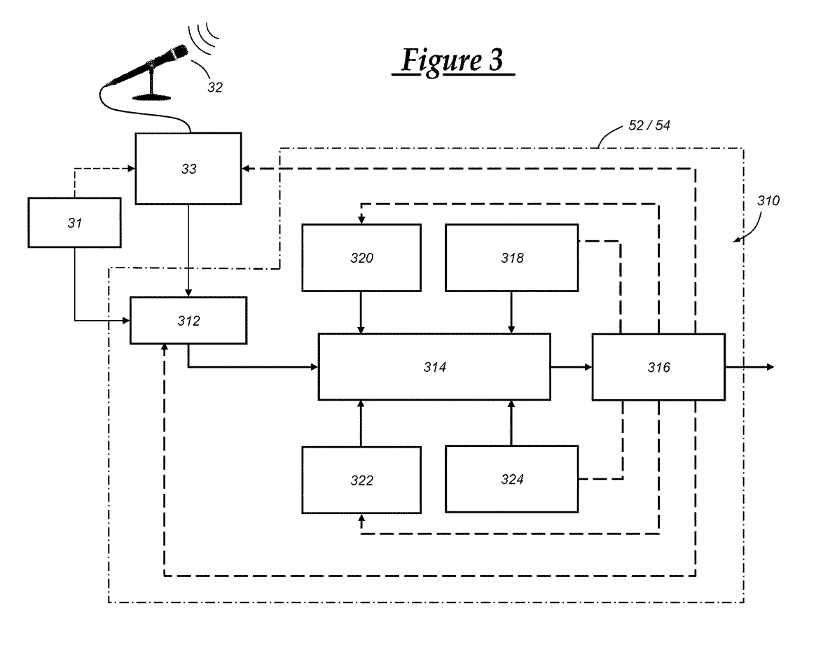

Turning now to FIG. 3, there is shown an exemplary architecture for an ASR system 310 that can be used to enable the presently disclosed method. In general, a vehicle occupant vocally interacts with an automatic speech recognition system (ASR) for one or more of the following fundamental purposes: training the system to understand a vehicle occupant's particular voice; storing discrete speech such as a spoken nametag or a spoken control word like a numeral or keyword; or recognizing the vehicle occupant's speech for any suitable purpose such as voice dialing, menu navigation, transcription, service requests, vehicle device or device function control, or the like. Generally, ASR extracts acoustic data from human speech, compares and contrasts the acoustic data to stored subword data, selects an appropriate subword which can be concatenated with other selected subwords, and outputs the concatenated subwords or words for post-processing such as dictation or transcription, address book dialing, storing to memory, training ASR models or adaptation parameters, or the like.

ASR systems are generally known to those skilled in the art, and FIG. 3 illustrates just one specific exemplary ASR system 310. The system 310 includes a device to receive speech such as the telematics microphone 32, and an acoustic interface 33 such as a sound card of the telematics unit 30 having an analog to digital converter to digitize the speech into acoustic data. The system 310 also includes a memory such as the telematics memory 54 for storing the acoustic data and storing speech recognition software and databases, and a processor such as the telematics processor 52 to process the acoustic data. The processor functions with the memory and in conjunction with the following modules: one or more front-end processors, pre-processors, or pre-processor software modules 312 for parsing streams of the acoustic data of the speech into parametric representations such as acoustic features; one or more decoders or decoder software modules 314 for decoding the acoustic features to yield digital subword or word output data corresponding to the input speech utterances; and one or more back-end processors, post-processors, or post-processor software modules 316 for using the output data from the decoder module(s) 314 for any suitable purpose.

The system 310 can also receive speech from any other suitable audio source(s) 31, which can be directly communicated with the pre-processor software module(s) 312 as shown in solid line or indirectly communicated therewith via the acoustic interface 33. The audio source(s) 31 can include, for example, a telephonic source of audio such as a voice mail system, or other telephonic services of any kind.

One or more modules or models can be used as input to the decoder module(s) 314. First, grammar and/or lexicon model(s) 318 can provide rules governing which words can logically follow other words to form valid sentences. In a broad sense, a lexicon or grammar can define a universe of vocabulary the system 310 expects at any given time in any given ASR mode. For example, if the system 310 is in a training mode for training commands, then the lexicon or grammar model(s) 318 can include all commands known to and used by the system 310. In another example, if the system 310 is in a main menu mode, then the active lexicon or grammar model(s) 318 can include all main menu commands expected by the system 310 such as call, dial, exit, delete, directory, or the like. Second, acoustic model(s) 320 assist with selection of most likely subwords or words corresponding to input from the pre-processor module(s) 312. Third, word model(s) 322 and sentence/language model(s) 324 provide rules, syntax, and/or semantics in placing the selected subwords or words into word or sentence context. Also, the sentence/language model(s) 324 can define a universe of sentences the system 310 expects at any given time in any given ASR mode, and/or can provide rules, etc., governing which sentences can logically follow other sentences to form valid extended speech.

According to an alternative exemplary embodiment, some or all of the ASR system 310 can be resident on, and processed using, computing equipment in a location remote from the vehicle 12 such as the call center 20. For example, grammar models, acoustic models, and the like can be stored in memory of one of the servers 82 and/or databases 84 in the call center 20 and communicated to the vehicle telematics unit 30 for in-vehicle speech processing. Similarly, speech recognition software can be processed using processors of one of the servers 82 in the call center 20. In other words, the ASR system 310 can be resident in the telematics unit 30 or distributed across the call center 20 and the vehicle 12 in any desired manner, and/or resident at the call center 20.

First, acoustic data is extracted from human speech wherein a vehicle occupant speaks into the microphone 32, which converts the utterances into electrical signals and communicates such signals to the acoustic interface 33. A sound-responsive element in the microphone 32 captures the occupant's speech utterances as variations in air pressure and converts the utterances into corresponding variations of analog electrical signals such as direct current or voltage. The acoustic interface 33 receives the analog electrical signals, which are first sampled such that values of the analog signal are captured at discrete instants of time, and are then quantized such that the amplitudes of the analog signals are converted at each sampling instant into a continuous stream of digital speech data. In other words, the acoustic interface 33 converts the analog electrical signals into digital electronic signals. The digital data are binary bits which are buffered in the telematics memory 54 and then processed by the telematics processor 52 or can be processed as they are initially received by the processor 52 in real-time.

Second, the pre-processor module(s) 312 transforms the continuous stream of digital speech data into discrete sequences of acoustic parameters. More specifically, the processor 52 executes the pre-processor module(s) 312 to segment the digital speech data into overlapping phonetic or acoustic frames of, for example, 10-30 ms duration. The frames correspond to acoustic subwords such as syllables, demi-syllables, phones, diphones, phonemes, or the like. The pre-processor module(s) 312 also performs phonetic analysis to extract acoustic parameters from the occupant's speech such as time-varying feature vectors, from within each frame. Utterances within the occupant's speech can be represented as sequences of these feature vectors. For example, and as known to those skilled in the art, feature vectors can be extracted and can include, for example, vocal pitch, energy profiles, spectral attributes, and/or cepstral coefficients that can be obtained by performing Fourier transforms of the frames and decorrelating acoustic spectra using cosine transforms. Acoustic frames and corresponding parameters covering a particular duration of speech are concatenated into unknown test pattern of speech to be decoded.

Third, the processor executes the decoder module(s) 314 to process the incoming feature vectors of each test pattern. The decoder module(s) 314 is also known as a recognition engine or classifier, and uses stored known reference patterns of speech. Like the test patterns, the reference patterns are defined as a concatenation of related acoustic frames and corresponding parameters. The decoder module(s) 314 compares and contrasts the acoustic feature vectors of a subword test pattern to be recognized with stored subword reference patterns, assesses the magnitude of the differences or similarities therebetween, and ultimately uses decision logic to choose a best matching subword as the recognized subword. In general, the best matching subword is that which corresponds to the stored known reference pattern that has a minimum dissimilarity to, or highest probability of being, the test pattern as determined by any of various techniques known to those skilled in the art to analyze and recognize subwords. Such techniques can include dynamic time-warping classifiers, artificial intelligence techniques, neural networks, free phoneme recognizers, and/or probabilistic pattern matchers such as Hidden Markov Model (HMM) engines.

HMM engines are known to those skilled in the art for producing multiple speech recognition model hypotheses of acoustic input. The hypotheses are considered in ultimately identifying and selecting that recognition output which represents the most probable correct decoding of the acoustic input via feature analysis of the speech. More specifically, an HMM engine generates statistical models in the form of an “N-best” list of subword model hypotheses ranked according to HMM-calculated confidence values or probabilities of an observed sequence of acoustic data given one or another subword such as by the application of Bayes' Theorem.

A Bayesian HMM process identifies a best hypothesis corresponding to the most probable utterance or subword sequence for a given observation sequence of acoustic feature vectors, and its confidence values can depend on a variety of factors including acoustic signal-to-noise ratios associated with incoming acoustic data. The HMM can also include a statistical distribution called a mixture of diagonal Gaussians, which yields a likelihood score for each observed feature vector of each subword, which scores can be used to reorder the N-best list of hypotheses. The HMM engine can also identify and select a subword whose model likelihood score is highest.

In a similar manner, individual HMMs for a sequence of subwords can be concatenated to establish single or multiple word HMM. Thereafter, an N-best list of single or multiple word reference patterns and associated parameter values may be generated and further evaluated.

In one example, the speech recognition decoder 314 processes the feature vectors using the appropriate acoustic models, grammars, and algorithms to generate an N-best list of reference patterns. As used herein, the term reference patterns is interchangeable with models, waveforms, templates, rich signal models, exemplars, hypotheses, or other types of references. A reference pattern can include a series of feature vectors representative of one or more words or subwords and can be based on particular speakers, speaking styles, and audible environmental conditions. Those skilled in the art will recognize that reference patterns can be generated by suitable reference pattern training of the ASR system and stored in memory. Those skilled in the art will also recognize that stored reference patterns can be manipulated, wherein parameter values of the reference patterns are adapted based on differences in speech input signals between reference pattern training and actual use of the ASR system. For example, a set of reference patterns trained for one vehicle occupant or certain acoustic conditions can be adapted and saved as another set of reference patterns for a different vehicle occupant or different acoustic conditions, based on a limited amount of training data from the different vehicle occupant or the different acoustic conditions. In other words, the reference patterns are not necessarily fixed and can be adjusted during speech recognition.

Using the in-vocabulary grammar and any suitable decoder algorithm(s) and acoustic model(s), the processor accesses from memory several reference patterns interpretive of the test pattern. For example, the processor can generate, and store to memory, a list of N-best vocabulary results or reference patterns, along with corresponding parameter values. Exemplary parameter values can include confidence scores of each reference pattern in the N-best list of vocabulary and associated segment durations, likelihood scores, signal-to-noise ratio (SNR) values, and/or the like. The N-best list of vocabulary can be ordered by descending magnitude of the parameter value(s). For example, the vocabulary reference pattern with the highest confidence score is the first best reference pattern, and so on. Once a string of recognized subwords are established, they can be used to construct words with input from the word models 322 and to construct sentences with the input from the language models 324.

Finally, the post-processor software module(s) 316 receives the output data from the decoder module(s) 314 for any suitable purpose. In one example, the post-processor software module(s) 316 can identify or select one of the reference patterns from the N-best list of single or multiple word reference patterns as recognized speech. In another example, the post-processor module(s) 316 can be used to convert acoustic data into text or digits for use with other aspects of the ASR system or other vehicle systems. In a further example, the post-processor module(s) 316 can be used to provide training feedback to the decoder 314 or pre-processor 312. More specifically, the post-processor 316 can be used to train acoustic models for the decoder module(s) 314, or to train adaptation parameters for the pre-processor module(s) 312.

### Method—

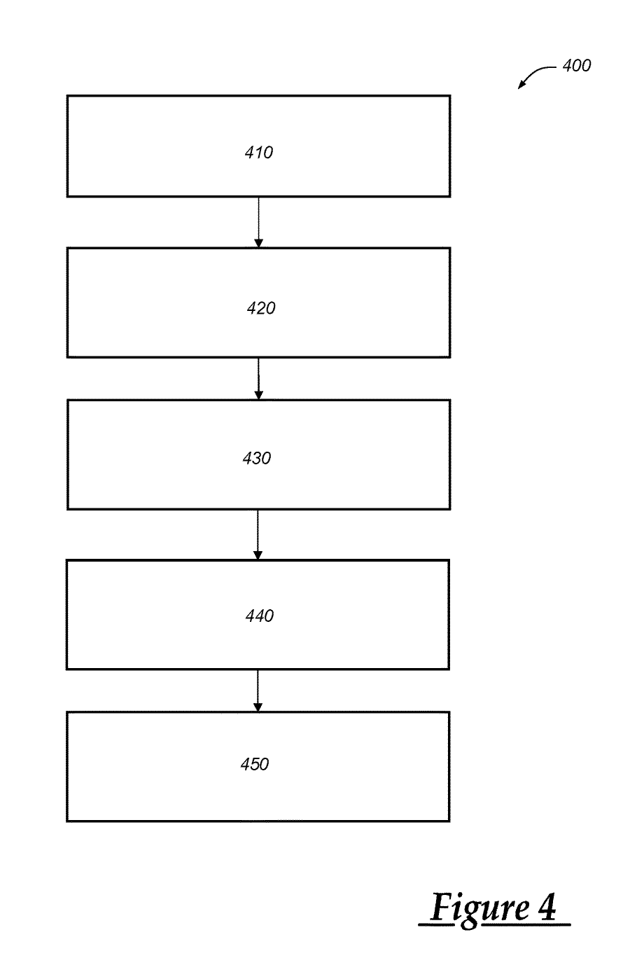

Turning now to FIG. 4, there is shown a method (400) of identifying and generating preferred emojis. The method 400 begins at step 410 by detecting a plurality of selected emojis at a wireless device. In this implementation, the wireless device will be described with respect to the smart phone 57. But it should be understood that other types of wireless devices capable of sending electronic messages can successfully perform the method. These devices include the vehicle telematics unit 30 described above or the infotainment head unit. Electronic messages generally include messages that allow the insertion of emojis communicated between the wireless device and a remote destination. The electronic messages can be email messages, text messages that are sent through SMS or a messaging software application, MMS, or other similar messaging protocols.

A software application can be used to monitor the identity of the emojis the device user includes in electronic messages and record the frequency with which each available emoji is selected. As a device user composes electronic messages, one or more emojis may be selected from a default emoji library and included in the messages. The default emoji library can be loaded onto the wireless device before it is delivered to the ultimate end user and includes hundreds of different emojis to choose from. The emojis each depict an artistic design or image and communicate a thought or feeling based on its design. For example, one emoji is described as “Face With Tears of Joy” depicting a smiling face with tears next to the eyes of the face. Many other emojis exist and a full description of each has been omitted. Each emoji can be associated with a hexidecimal code that identifies it. For instance, the “Face With Tears of Joy” emoji can be represented by a code ranging from 1F600-1F64F. The emojis' technical specifications are defined by the Unicode Consortium that establishes the Unicode Standard. The method 400 proceeds to step 420.

At step 420, the frequency with which each emoji is selected can be determined. The software application can monitor and record how many times each emoji in the default library has been selected by the device user for inclusion in an electronic message. The software application can be loaded onto the smart phone 57 where the processing capability of the smart phone 57 executes the functions of the software application and records the frequency with which emojis are selected in the memory included with the phone 57 over a period of time. In one implementation, the period of time can be a month but other time periods that are shorter or longer may be used. It is also possible to store the software application at the vehicle telematics unit 30. Regardless of the location of the software application, electronic messages composed using either the smart phone 57 or the vehicle electronics may be monitored. The vehicle telematics unit 30 and the smart phone 57 can communicate data indicating the selection of emojis via short-range wireless communications protocols. So, when a device user composes a message using the vehicle telematics unit 30 or an infotainment head unit, the vehicle-based device can send the identity and frequency of emoji selection to the smart phone 57 when the software application is stored at the smart phone 57 or vice versa. The method 400 proceeds to step 430.

At step 430, a defined number of emojis are identified from the plurality of selected emojis based on the frequency with which each emoji is selected. After monitoring the emoji selection during the period of time, the software application can identify which emojis the device user selects most frequently. For example, the software application may be configured to identify the thirty or forty most-frequently selected emojis that were measured over the period of time. The method proceeds to step 440.

At step 440, a frequently-used emoji library is created for the emojis. The smart phone 57 can establish a separate library containing information relating to the identified emojis. The frequently-used emoji library can include a text-based default description of each emoji, one or more alternative text-based descriptions of each emoji, and the hexidecimal identifier of each emoji. The alternative text-based descriptions of each emoji can be user-specified such that the user can type his or her own descriptions using the display 59 to add them to the frequently-used emoji library. Or the alternative text-based default description can be supplied from a survey. The survey can present emojis to a statistically significant number of people and receive descriptions of each emoji. Frequently-occurring descriptions received from the survey of people can be added to the frequently-used emoji library. While emoji identifiers have been described using hexidecimal code, it should be appreciated that other code formats can be used, such as binary code. The frequently-used emoji library may be configured for use with the TTS system 210 and the ASR system 310 described above. The method 400 proceeds to step 450.

At step 450, an electronic message is initiated at the smart phone 57 and the user selects emojis from the frequently-used emoji library for inclusion in the electronic message. The device user can compose an electronic message and include with that message one or more emojis. The device user can verbally compose the message and the content can be received by either the smart phone 57 or the vehicle telematics unit 30. For example, the smart phone 57 can receive speech from the device user and communicate the speech to the ASR system 310 at the vehicle 12 via short-range wireless communication techniques. Or in another implementation, the vehicle 12 can receive speech from the user via the microphone 32 and process the speech using the ASR system 310. The ASR system 310 can load the frequently-used emoji library as a text sentence or language model 324. The frequently-used emoji library can provide greater efficiency when processing speech to include emojis in electronic messages. Rather than including a text source having definitions for each possible emoji, the frequently-used emoji library can provide information regarding the most-commonly occurring emojis as measured from the particular device user's behavior.

The device user, as part of dictating the content of an electronic message, can recite the emoji he or she wants to include in the message. The ASR system 310 can process the speech and identify spoken emoji descriptions using the frequently-used emoji library. Continuing the example begun above, the device user can recite the text to be included in the message body and also say the words “Face With Tears of Joy.” The ASR system 310 can recognize this description of an emoji and insert the “Face With Tears of Joy” emoji into the electronic message along with the text.

In another implementation, the wireless device can receive a user-defined input identifying an emoji for inclusion in the electronic message. The frequently-used emoji library can be configured to associated user-defined inputs with particular emojis. When the smart phone 57 or vehicle telematics unit 30 detects the device user performing the user-defined input, the emoji associated with the input can be inserted into an electronic message. The user-defined input can be a facial expression made by the device user or a particular pattern drawn by the device user using his or her finger(s). The smart phone 57 can be placed in a training mode during which its camera can record the facial expression of the device user. As the device user establishes a particular facial expression, the user can also select a particular emoji to associate with the particular facial expression. The smart phone 57 can then record the facial expression—emoji association in the frequently-used emoji library. Different facial expressions can be assigned to different emojis in the frequently-used emoji library. The smart phone 57 can then end the training mode and return to normal operation. During normal operation, the device user may compose electronic messages and direct the smart phone camera toward his or her face. The user can then configure the face into the facial expression associated with an emoji to be selected. The smart phone 57 can compare the images received from the camera with images associated with emojis in the frequently-used emoji library. When a match is found, the smart phone 57 may insert the associated emoji into the electronic message.

With respect to other user-defined inputs, different emojis can each be associated with particular pattern drawn be the device user. The smart phone 57 can be placed in a training mode during which its display 59 can record a particular pattern drawn by the device user. For instance, the device user can make an “X” with a finger along the surface of the display 59. As the device user draws a particular pattern, the user can also select a particular emoji to associate with the pattern. The smart phone 57 can then record the drawn pattern—emoji association in the frequently-used emoji library. Different patterns can be assigned to different emojis in the frequently-used emoji library. The smart phone 57 can then end the training mode and return to normal operation. During normal operation, the device user may compose electronic messages and then trace the pattern over the display 59 when he or she wants to insert a particular emoji in the message. The smart phone 57 can compare the pattern it detects with patterns associated with emojis in the frequently-used emoji library. When a match is found, the smart phone 57 may insert the associated emoji into the electronic message.

The frequently-used emoji library can also be used by the TTS system 210 to generate spoken descriptions of emojis included in electronic messages processed by the wireless device. For example, the wireless device can identify the emoji(s) included in the message by unique hexidecimal codes associated with the emoji(s) and also included in the message. The identified hexidecimal codes can be compared with the hexidecimal codes identifying emojis in the frequently-used emoji library. The TTS system 210 can generate speech from the descriptions associated with matching emojis; the frequently-used emoji library can be used as a text source 212 to generate speech representing the emojis. The method 400 then ends.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of identifying and generating preferred emojis, comprising the steps of:
(a) detecting at a wireless device a plurality of selected emoji;
(b) determining the frequency with which each emoji is selected;
(c) identifying a defined number of emojis from the plurality of selected emojis based on the frequency with which each emoji is selected; and
(d) creating a frequently-used emoji library for the emojis identified during step (c).

2. The method of claim 1, wherein the wireless device comprises a vehicle telematics unit.

3. The method of claim 1, wherein the wireless device comprises a smart phone.

4. The method of claim 1, further comprising the step of loading the frequently-used emoji library as a model for an automatic speech recognition (ASR) system.

5. The method of claim 1, further comprising the steps of associating one or more user-defined descriptions with each emoji and storing those descriptions in the frequently-used emoji library.

6. The method of claim 1, further comprising the steps of associating one or more descriptions generated from a survey with each emoji and storing those descriptions in the frequently-used emoji library.

7. A method of identifying and generating preferred emojis, comprising the steps of:
(a) initiating an electronic message at a wireless device;
(b) receiving speech describing an emoji for inclusion in the electronic message;
(c) comparing the received speech with emoji descriptions stored in a frequently-used emoji library;
(d) identifying an emoji based on the comparison; and
(e) inserting the emoji into the electronic message.

8. The method of claim 7, wherein the wireless device comprises a vehicle telematics unit.

9. The method of claim 7, wherein the wireless device comprises a smart phone.

10. The method of claim 7, further comprising the step of loading the frequently-used emoji library as model for an automatic speech recognition (ASR) system.

11. The method of claim 7, wherein the emoji descriptions comprise both user-defined descriptions and default descriptions.

12. The method of claim 7, wherein the emoji descriptions comprise descriptions generated from a survey.

13. A method of identifying and generating preferred emojis, comprising the steps of:
(a) initiating an electronic message at a wireless device;
(b) receiving a user-defined input identifying an emoji for inclusion in the electronic message;
(c) comparing the received user-defined input with previously-stored user-defined input and emoji associations stored in a frequently-used emoji library;
(d) identifying an emoji based on the comparison; and
(e) inserting the emoji into the electronic message.

14. The method of claim 13, wherein the wireless device comprises a vehicle telematics unit.

15. The method of claim 13, wherein the wireless device comprises a smart phone.

16. The method of claim 13, further comprising the step of loading the frequently-used emoji library as a model for an automatic speech recognition (ASR) system.

17. The method of claim 13, wherein the user-defined input comprises a facial expression.

18. The method of claim 13, wherein the user-defined input comprises a pattern drawn by a user of the wireless device.

19. The method of claim 13, further comprising the step of receiving an emoji selection from a device user and associating the emoji selection with a received facial expression.

20. The method of claim 13, further comprising the step of receiving an emoji selection from a device user and associating the emoji selection with a received pattern drawn by a user of the wireless device.
